(19) United States
(12) Patent Application Publication
(10) Pub. No.: US 2004/0078973 A1
(43) Pub. Date: Apr. 29, 2004

(54) Glow plug puller

(76) Inventor: James Earl Daniel, Richland, MO (US)

Correspondence Address: JAMES E. DANIEL, 3006 MOUNTVIEW RD., RICHLAND, MO, 65556, US

(21) Appl. No.: 10/237,700

(22) Filed: Oct. 24, 2002

(51) Int. Cl. B23P 6/00

(52) U.S. Cl. 29/888.011

(57) ABSTRACT

When the proper puller is put into the body and adjusted to fit over the mushroomed glow plug, tighten the outer body down unit it tightens against the head of the engine. Using a ¼ inch drive ratchet with the size required extension. Turn the inside of the puller tool counter clockwise while holding the body in place. Turn until damaged glow plug is clear of the engine head. Repeat the method until all mushroomed plugs are out.

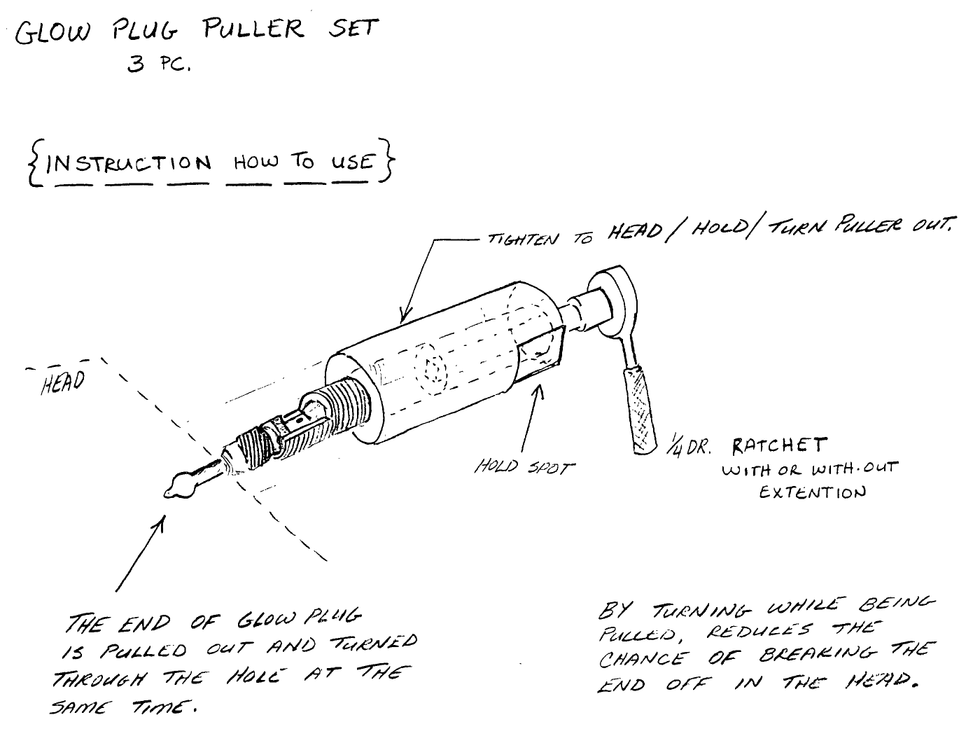

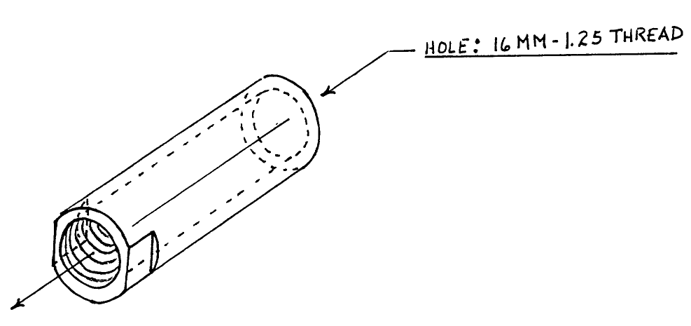

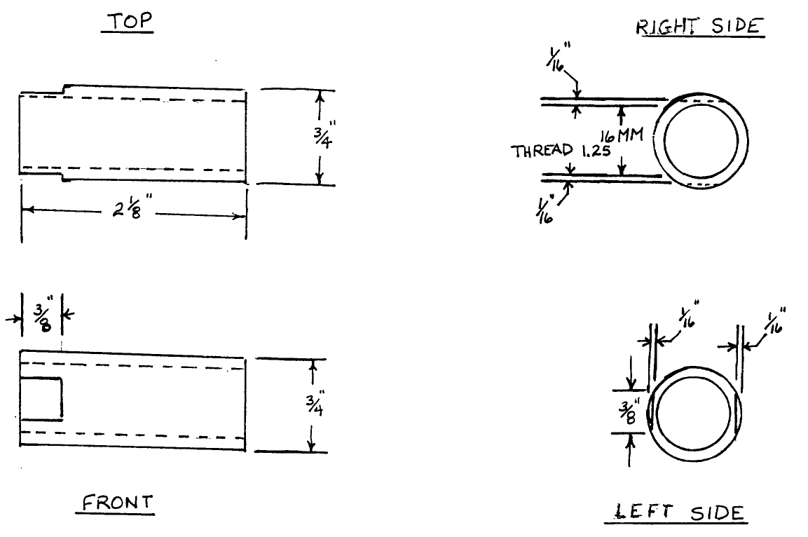

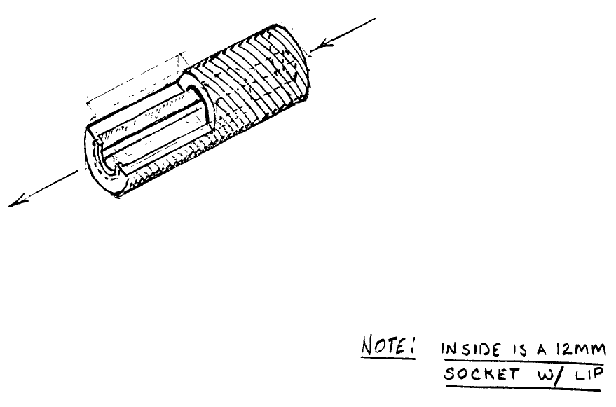

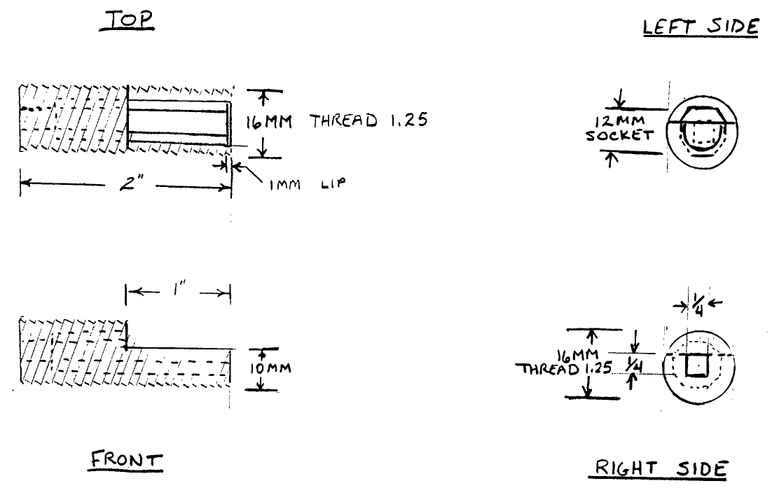

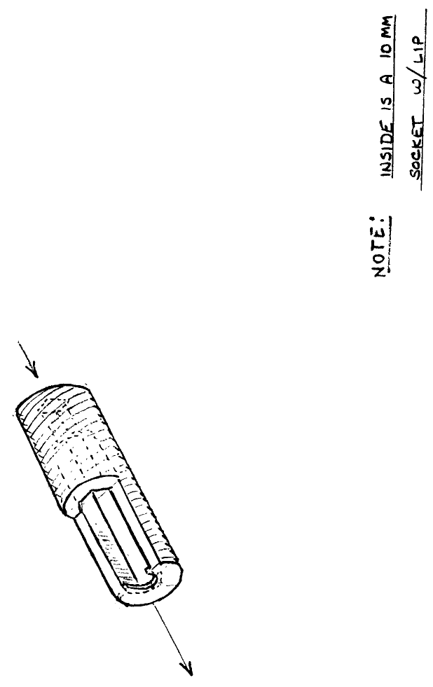

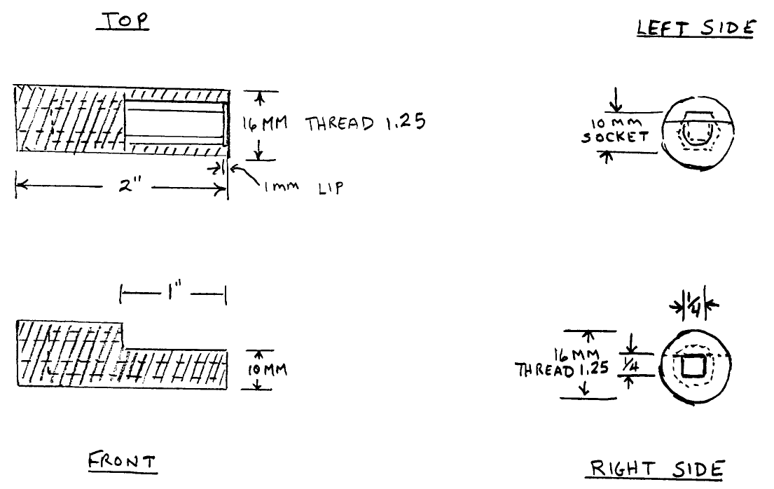

### DESCRIPTION

1. Field of Invention

A METHOD AND APPARATUS IS DISCLOSED FOR REMOVING MUSHROOMED GLOW PLUGS OUT OF THE HEADS OF A AUTOMOTIVE DIESEL ENGINE.

2. Background of Tool

AUTOMOTIVE DIESEL VEHICLES WITH 10 MM AND 12 MM GLOW PLUGS. WHEN THE GLOW PLUG MUSHROOMS INSIDE THE ENGINE HEAD, SOMETIMES THE GLOW PLUG MUSHROOMS SO MUCH THAT IT WILL NOT COME OUT OF THE HOLE AFTER IT IS UNSCREWED FROM THE HEAD. WHEN THIS HAPPENS YOU HAVE TOPUTLL IT OUT WITHOUT BREAKING THE GLOW PLUG.

THE GLOW PLUG PULLER IS USED WHEN THE GLOW PLUG WILL NOT COME OUT OF THE ENGINE HEAD. THIS ALL STEEL 3 PIECE TOOL IS USED TO PULL AS IT TURNS TO REDUCE THE CHANCE OF BREAKING THE BOTTOM OF THE GLOW PLUG OFF INTO THE HEAD.

### BRIEF DESCRIPTION OF THE DRAWINGS

DRAWING 1 OF 6 IS A 3-D VIEW OF THE BODY. A STEEL CYLINDER THAT IS THREADED INSIDE AND HAS TWO HOLDING SLOTS ON ONE END.

DRAWING 2 OF 6 IS A TO SCALE, TOP, FRONT AND END WITH DIMENTIONS OF DRAWING 1 OF 6.

DRAWING 3 OF 6 IS A 3-D VIEW OF THE 12 MM PULLER WITH A CUT AWAY AND A LIP.

DRAWING 4 OF 6 IS A TO SCALE, TOP, FRONT AND END WITH DIMENTIONS OF DRAWING 3 OF 6.

DRAWING 5 OF 6 IS A 3-D VIEW OF THE 10 MM PULLER WITH A CUT AWAY AND A LIP.

DRAWING 6 OF 6 IS A TO SCALE, TOP, FRONT AND END WITH DIMENTIONS OF DRAWING 5 OF 6.

DRAWING WITH GLOW PLUG PULLER SET 3 PIECE, IS INSTRUCTIONS ON HOW TO USE THE TOOL.

1. A METHOD OF REMOVING MUSHROOMED GLOW PLUGS FROM AUTOMOTIVE DIESEL ENGINES WITHOUT BREAKING THEM.
USING THE TOOL WITH THE PROPER (10 MM OR 12 MM) INSERT PULLER TO FIT THE GLOW PLUG.
USING A ¼ INCH RATCH TIGHTEN THE BODY DOWN TO THE ENGINE HEAD UNTIL SNUG.
HOLD THE BODY AND UNSCREEN THE PULLER UNTIL THE MUSHROOMED PLUG COMES OUT OF THE HEAD.
THE PULLING OUT WHILE TURNING REDUCES THE CHANGE OF BREAKING THE GLOW PLUG.
